(19) United States
(12) Patent Application Publication
(10) Pub. No.: US 2009/0316201 A1
(43) Pub. Date: Dec. 24, 2009

(54) DISPLAY-INTEGRATED IMAGE FORMING APPARATUS, IMAGE DISPLAY SYSTEM, AND IMAGE DISPLAY METHOD

(76) Inventors: Yasuhiro NAKAI, Osaka (JP); Satoshi MACHINO, Osaka (JP); Osamu UEDA, Osaka (JP)

Correspondence Address: BIRCH STEWART KOLASCH & BIRCH, PO BOX 747, FALLS CHURCH, VA, 22040-0747, US

(21) Appl. No.: 12/486,480

(22) Filed: Jun. 17, 2009

(30) Foreign Application Priority Data
Jun. 18, 2008 (JP) 2008-159348

(51) Int. Cl. G06F 15/00

(52) U.S. Cl. 358/1.15

(57) ABSTRACT

A large-format display is attached to a rear side face of a digital multifunction peripheral in an integrated manner, with a first display screen facing outside and a second display screen facing inside. A device control portion of the digital multifunction peripheral is connected to an external server apparatus via an external network. In this digital multifunction peripheral, various pieces of information managed by the server apparatus are displayed on the first display screen and the second display screen of the large-format display, and when switching the display of the display screens sequentially with time, the display of the first display screen and the display of the second display screen are switched with a time lag.

### BACKGROUND OF THE INVENTION

This application claims priority under 35 U.S.C. §119(a) on Patent Application No. 2008-159348 filed in Japan on Jun. 18, 2008, the entire contents of which are herein incorporated by reference.

The present invention relates to an image forming apparatus such as a multifunction peripheral or digital copier, and more specifically relates to a display-integrated image forming apparatus in which a large-format display apparatus is integrated with an image forming apparatus, and to an image display system and an image display method.

Recently, many image forming apparatuses such as multifunction peripherals and digital copiers are installed in mass retail stores or the like such as convenience stores and supermarkets, and such image forming apparatuses are used mainly, for example, when a user that uses the store takes a copy of an original.

Incidentally, in recent convenience stores, the section of the store that faces the street (walkway) is entirely encased in glass, and products are displayed such that people walking along the walkway can view and see the state of the inside of the store at a glance. For example, in an ordinary arrangement pattern as shown in FIG. 16, a wide space-side glass window 501 and a narrow space-side glass window 502 are provided with an entrance 500 between them, a bookshelf 510 is placed along the wide space-side glass window 501, an image forming apparatus A is placed along the narrow space-side glass window 502, and a register counter (not shown) is disposed behind the image forming apparatus A within the store. In such an arrangement configuration, conventionally, paper advertisements 505 such as posters are directly posted, facing out of the store, to the walkway-side glass windows 501 and 502, so as to publicise various publicity activities to pedestrians. Publicity activities to customers inside the store are publicised by posting paper advertisements in the small amounts of open space on display shelves within the store.

During such publicity activities, it is difficult to frequently change advertisements, so there is a problem in that flexible publicity activities according to the time of day are not possible, such as, for example, advertising that targets businessmen during a time period of the day in which many businessmen pass by, and advertising that targets housewives and students during the daytime, in which many housewives and students pass by.

Also, the technique in which the walkway-side of the store is entirely encased in glass and advertisements are posted on that glass face is also adopted by real estate companies and the like, so that various real estate advertisements posted all over the glass face wall are provided to passers-by. However, in this case as well, it is necessary for employees to manually remove information on real estate that is under a rental contract or purchase contract, and post new real estate information or the like, and this is problematic in that removal, posting, or the like is frequently forgotten and, therefore, the provided information may not be the newest information.

In addition, as already described above, currently, the image forming apparatus placed in each store is mainly used only when a user of the store takes a copy of an original and is rarely used for other purposes. Accordingly, attempts have been made to improve the usage efficiency of such an image forming apparatus (see, for example, JP 2002-329139A, JP 2002-156873A and JP 2002-55501A).

JP 2002-329139A (hereinafter referred to as Patent Document 1) describes an advertisement information processing system in which a wall display and a printer connected to each other are placed in a store, and when a print button that corresponds to advertisement information displayed on the wall display is pressed, the advertisement information for which that print button was pressed can be printed by the printer.

JP 2002-156873A (hereinafter referred to as Patent Document 2) describes an image processing apparatus that serves as a copier and is connected to a cash register with a LAN, and when a poster image original that has been placed on a platen of the copier is captured, the poster image is displayed on an operation screen of the copier and also on a display apparatus of the cash register via the LAN.

JP 2002-55501A (hereinafter referred to as Patent Document 3) describes an image forming apparatus that has a liquid crystal monitor in a front face or side face of the main body of the image forming apparatus, and that is configured to display the output signal from a personal computer on the display portion of the liquid crystal monitor.

As described above, there have been attempts to increase advertising publicity functionality using an image forming apparatus, by connecting the image forming apparatus to a display apparatus, and printing advertising information displayed on the display apparatus with the image forming apparatus, or displaying a poster image that has been captured with the image forming apparatus on an operation screen of the image forming apparatus or on a display apparatus of a cash register.

However, in the technique described in Patent Document 1, it is necessary to install a display along the entire walkway-side wall face, and connect the display to a printer installed within the store with a communications cable, so a lot of installation work is needed, and installation in each store is necessary, so there is a problem in that such installation work is very complicated. There is also another problem in that the layout cannot be changed easily after it is installed once, even when it is necessary to change the layout according to circumstances.

Furthermore, in the technique described in Patent Document 2, although advertising information can be displayed on an operation screen of an image forming apparatus or a display screen of a cash register, this is a publicity advertisement to customers inside the store, and not a publicity advertisement to people walking along the walkway in front of the store. There is also a problem in that by only displaying advertising information on an operation screen of an image forming apparatus or a display screen of a cash register, even most customers inside the store do not notice the advertising information; thus, an adequate publicity effect is not obtained.

Furthermore, according to Patent Documents 1 and 2, data such as advertisement information is stored in each of the apparatuses installed in stores and the like, so more storage capacity will be needed as the data increases.

Furthermore, in the technique described in Patent Document 3, although advertising information can be displayed on a display screen of a liquid crystal monitor, this is a display for the operator of the image forming apparatus. The technique described in Patent Document 3 is not based on a technical idea for providing information to those other than the operator.

A technique is also adopted in which an image forming apparatus and a large screen (for example, a 50-inch screen, etc.) display apparatus connected by a cable are installed in stores, but in a store such as a convenience store or a supermarket, the issue is to secure as large a selling area as possible, and because placement of two large devices in this manner results in a reduction in selling area, this technique has not been widely adopted. In addition, in a small store, it may not be possible to secure an installation location for such large devices, and so the system is not necessarily advantageous to the store. For example, the outer dimensions of a 52-inch liquid crystal display (Sharp PN-525) are a height of 1254 mm×a width of 742 mm×a depth of 92 mm, and a weight of 44 Kg. The outer dimensions of a liquid crystal display stand (Sharp ID-DS03W) are a width of 917 mm×a depth of 870 mm. The outer dimensions of a digital multifunction peripheral (Sharp MX-3500FN) are a height of 950 mm×a width of 645 mm×a depth of 670 mm, and a weight of 120 Kg. Here, if the liquid crystal display and the digital copier are placed in series, the necessary occupied floor area will be the width: liquid crystal display stand width of 917 mm×the depth: 1540 mm (digital copier depth of 670 mm+liquid crystal display stand depth of 870 mm).

The present invention has been conceived to address the problems described above, and it is an object of the present invention to provide display-integrated image forming apparatuses, image display systems, and image display methods with which it is possible to provide adequate publicity advertisements to walkway pedestrians without requiring a large installation location, and to smoothly perform such publicity advertisement operations.

### SUMMARY OF THE INVENTION

In order to address the above problems, a display-integrated image forming apparatus of the present invention includes an image forming apparatus that performs a print operation with a print portion in response to an operation through an operation portion; a first display apparatus arranged at least on one side of a case of the image forming apparatus, the first display apparatus including a first display screen viewable from a rear face or a side face when viewed from an operation side of the image forming apparatus; a second display apparatus arranged so as to protrude above the case of the image forming apparatus, the second display apparatus including a second display screen viewable by an operator of the image forming apparatus; and a display control portion that displays various pieces of information that related to the first display screen and the second display screen, and that sequentially switches the displays on the display screens (the first display screen and the second display screen) with time, wherein the display control portion switches the display on the first display screen and the display on the second display screen with a time lag. Also, in this configuration, it is possible that aside from the operation portion, the second display screen serves as a second operation portion, and operation is possible from either or both of the operation portion and the second operation portion.

According to such a configuration, the image forming apparatus is used also as a leg portion of the display apparatus (at least one of the first display apparatus and the second display apparatus), and it is thus possible to fit two large devices, namely the image forming apparatus and the display apparatus, substantially within the installation space of the image forming apparatus. As already mentioned above, if the liquid crystal display, which is the display apparatus, and the digital copier, which is the image forming apparatus, are placed in series, the necessary occupied floor area will be the width: liquid crystal display stand width of 917 mm×the depth: 1540 mm (digital copier depth 670 mm+liquid crystal display stand depth 870 mm), but if the liquid crystal display is attached to the rear face of the digital multifunction peripheral, the necessary occupied floor area will be only the width: liquid crystal display width of 742 mm×the depth: 762 mm (liquid crystal display depth of 92 mm+digital multifunction peripheral depth of 670 mm). Also, balance is poor when the liquid crystal display is placed vertically, but by being integrated with the digital multifunction peripheral, the weight balance of the digital multifunction peripheral and the liquid crystal display will be balanced, so stable installation is possible. Thus, even in a small store such as a convenience store or a supermarket, the image forming apparatus can be installed in the same location almost in the same manner as a conventional image forming apparatus. In this case, when the display apparatus (the first display screen) is attached to, for example, the rear face of the image forming apparatus such that the display screen (the first display screen) faces outside, by only installing the image forming apparatus inside the store in a conventional manner, the display screen of the display apparatus (the first display screen of the first display apparatus) faces pedestrians outside the store through the street-side (i.e., the walkway-side) wall face glass. Accordingly, by displaying advertising information on the display screen of this display apparatus (the first display screen of the first display apparatus), it is possible to provide publicity advertisements with impact to pedestrians outside the store.

Also in the present invention, the display on the first display screen and the display on the second display screen are, respectively, sequentially switched with time. In this case, when a person who viewed the first display screen desires to perform printing or the like of the information, if the display on the second display screen has been switched before the person performs an operation with the second display screen, that person is required to cause the screen displayed before switching to appear again on the second display screen or wait until the next display cycle, so it is highly probable that a smooth operation cannot be achieved. Therefore, in the present invention, the display on the first display screen and the display on the second display screen are switched with a time lag. Specifically, a certain display on the second display screen is switched with a delay after the switching of the same display on the first display screen. That is, for the same display, the display on the second display screen is switched with a delay relative to the switching of the display on the first display screen. In this manner, even if the display on the first display screen has been switched by the time a person who viewed the first display screen arrives in front of the second display screen in order to perform printing or the like of the displayed information, the same display is still on the second display screen and, therefore, the person can perform a desired operation through the display on the second display screen. In other words, since there is no need for an operation causing the desired display to appear again on the second display screen or to wait for the next display cycle, it is possible to perform a desired operation smoothly.

In the above configuration, the time lag may be set arbitrarily. The time required from viewing the first display screen to arriving in front of the second display screen and performing a desired operation differs depending on the installation conditions or the like of the store where the apparatus is installed. Therefore, by enabling the time lag in switching displays to be set freely, it is possible for the manager who manages the apparatus to set an optimal time lag for each store.

In the above configuration, it is possible that when a desired piece of information is selected from the information displayed on the display apparatus (through the operation portion or the second operation portion), the display control portion displays the selected piece of information on the second display screen, and transitional display in which a display on a screen is sequentially switched with time is suspended for the second display screen. Furthermore, in this configuration, the transitional display in which a display on a screen is sequentially switched with time may be continued for the display of the first display screen. Also, in this configuration, it is possible that when processing based on the selected piece of information displayed on the second display screen is completed, the display on the second display screen returns to the transitional display in which a display on a screen is sequentially switched with time.

With such a configuration, when the operator has selected a desired piece of information, the information displayed at the time of the selection remains displayed on the second display screen rather than switching to another display, and therefore the operator can perform an operation while viewing the second display screen without the need to hurry. Furthermore, the display on the first display screen keeps sequentially switching its display, and therefore advertisement to people other than the operator can be continuously provided.

It should be noted that information displayed on the display apparatus (at least one of the first display screen of the first display apparatus and the second display screen of the second display apparatus) is managed by a management portion of the image forming apparatus. Alternatively, in an image display system, in which the display-integrated image forming apparatus according to the present invention and an external server apparatus are connected to each other via a network, information displayed on the display apparatus (at least one of the first display screen of the first display apparatus and the second display screen of the second display apparatus) may be managed by the server apparatus. By managing information collectively with the server apparatus, the storage capacity of the display-integrated image forming apparatus installed in the store can be reduced.

Also, the image display method of the present invention is employed in the above display-integrated image forming apparatus according to the present invention, and includes the steps of displaying various pieces of information that related to the first display screen and the second display screen, and sequentially switching a display on the display screens (the first display screen and the second display screen) with time; and switching the display on the first display screen and the display on the second display screen with a time lag. With such an image display method, when a person who viewed the first display screen arrives in front of the second display screen in order to perform printing or the like of the displayed information, even if that display has been switched on the first display screen by that time, the same display is still on the second display screen and, therefore, the person can perform a desired operation through the display on the second display screen.

Also, the image display method of the present invention may further include the steps of: when a desired piece of information is selected through the operation portion from the information displayed on the display apparatus (at least one of the first display screen of the first display apparatus and the second display screen of the second display apparatus), displaying the selected piece of information on the second display screen, and suspending transitional display in which a display on the second screen is sequentially switched with time for the second display screen; and when processing based on the selected piece of information displayed on the second display screen is completed, returning the display of the second display screen to the transitional display in which display on the second screen is sequentially switched with time. With such a configuration, when the operator has selected a desired piece of information, the information displayed on the second display screen at the time of the selection remains displayed on the second display screen rather than being switched to another display and, therefore, the operator can perform an operation while viewing the second display screen without the need to hurry.

As described above, according to the present invention, by using the image forming apparatus also as a leg portion of the display apparatus (the first display apparatus and the second display apparatus), it is possible to fit two large devices, namely, the image forming apparatus and the display apparatus (the first display apparatus and the second display apparatus), substantially within the installation space of the image forming apparatus. Thus, even in a small store such as a convenience store or a supermarket, the image forming apparatus can be installed in the same location almost in the same manner as a conventional image forming apparatus. In this case, when the display screen (the first display screen) is attached to the image forming apparatus such that the display screen faces outside, by only installing the image forming apparatus inside the store in a conventional manner, the display screen of the display apparatus (the first display screen of the first display apparatus) faces pedestrians outside the store through the street-side (i.e., the walkway-side) wall face glass. Accordingly, by displaying advertising information on the display screen of this display apparatus (the first display screen of the first display apparatus), it is possible to provide publicity advertisements with impact to pedestrians outside the store.

Also according to the present invention, by providing a time lag in the switching of the display between the first display screen and the second display screen, when a person who viewed the first display screen arrives in front of the second display screen in order to perform printing or the like of the displayed information, even if that display on the first display screen has been switched by that time, the same display is still on the second display screen and, therefore, the opeartor can perform a desired operation through the display on the second display screen.

### BRIEF DESCRIPTION OF THE DRAWINGS

FIGS. 1A, 1B and 1C are outer perspective views of a display-integrated image forming apparatus according to an embodiment of the present invention.

FIG. 2 shows an example in which a display-integrated image forming apparatus of the present invention is installed in a convenience store, with FIG. 2A being a perspective view, and FIG. 2B being a plan view.

FIG. 3 is a perspective view of a display-integrated image forming apparatus according to another embodiment of the present invention, in which a large-format display is attached to one side face case of an image forming apparatus.

FIG. 4 is a plan view showing an example in which a display-integrated image forming apparatus with a large-format display attached to a side face case is installed in a convenience store.

FIGS. 6A, 5B, 5C and 5D are perspective views of display-integrated image forming apparatuses according to still another embodiment of the present invention, in which large-format displays are attached to the rear face case and a side face case of an image forming apparatus.

FIG. 6 is a perspective view of a display-integrated image forming apparatus according to still another embodiment of the present invention, in which a large-format display is disposed on a side face case of the image forming apparatus and a second display screen is disposed such that the second display screen protrudes from the back face of the image forming apparatus.

FIG. 7 is a block diagram illustrating an electrical configuration when a display-integrated image forming apparatus of the present invention is applied to a digital multifunction peripheral.

FIG. 8 is a block diagram illustrating an electrical configuration of a server apparatus.

FIG. 9 is an explanatory diagram illustrating a configuration of an operation portion.

FIG. 10 is an explanatory diagram illustrating an example of the transition of display on a first display screen and a second display screen managed by a server apparatus.

FIG. 11 is an explanatory diagram illustrating an example of the transition of display when an operator has selected desired advertising information during the transition of display in FIG. 10.

FIG. 12 is an explanatory diagram illustrating a transitional display example of advertisement data for a convenience store, supermarket or the like displayed on a first display screen of a large-format display.

FIG. 13 is an explanatory diagram illustrating a transitional display example of advertisements 1 to 4 displayed on a second display screen of a large-format display.

FIG. 14 is an explanatory diagram illustrating an exemplary operation performed from a food top page displayed on a second display screen of a large-format display.

FIG. 15 is an explanatory diagram illustrating a display example of thumbnail images displayed in a display panel.

FIG. 16 illustrates an ordinary arrangement configuration of a convenience store.

### DESCRIPTION OF THE PREFERRED EMBODIMENTS

Hereinafter, embodiments of the present invention will be described with reference to the accompanying drawings.

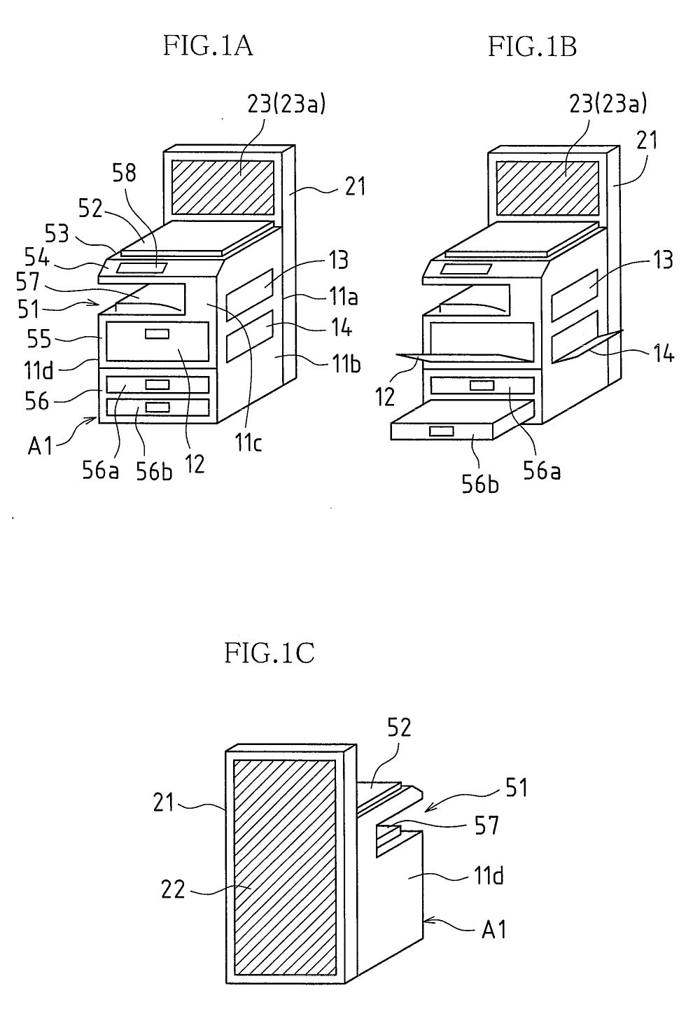

FIGS. 1A, 1B and 1C are outer perspective views of a display-integrated image forming apparatus according to an embodiment of the present invention.

An image forming apparatus A1 is an image forming apparatus with an in-body paper discharge structure formed in a sideways U shape when viewed from the front. In the image forming apparatus A1, an original pressing lid 52, an original capturing portion 53, and a scanner portion 54 are disposed above an in-body paper discharge opening portion 51, and an image forming portion 55 and a paper supply portion 56 are disposed below the in-body paper discharge opening portion 51. Also, a keyboard-type and touch panel-type operation portion 58 (a first operation portion in the present invention) is disposed on the front face side of the original capturing portion 53.

That is, the image forming apparatus A1 is surrounded by a rear face case 11a and a right side face case 11b formed in a rectangular shape, an approximately rectangular front face case 11c where the in-body paper discharge opening portion 51 is notched in a sideways U shape, and a left side face case 11d, and the top of these case portions is covered by the scanner portion 54, which includes the original pressing lid 52 and the original capturing portion 53. Also, although not shown, casters are provided at each case bottom corner, so that the image forming apparatus can be freely moved by pushing.

The image forming apparatus A1 is a front access-type image forming apparatus in which, when an original is placed on the original capturing portion 53, when recording paper is drawn from a discharge tray 57 of the in-body paper discharge opening portion 51, and when recording paper is replenished in the paper supply portion 56, these activities can be performed from the front face of the image forming apparatus. Also, a front door 12 is provided immediately below the in-body paper discharge opening portion 51 of the front face case 11c, side doors 13 and 14 are provided at two locations above and below in the right side face case 11b, and respective paper cassettes 56a and 56b of the paper supply portion 56 are disposed so as to be capable of being pulled out to the front, below the front door 12. By opening the front door 12, it is possible to perform maintenance such as toner replenishment, exchanging of a photosensitive body, and repair or exchange of a fixing unit or a charging unit. Also, when removing jammed recording paper from a paper transport path, the side doors 13 and 14 are opened as necessary. However, other than disposing the discharge tray 57 in the in-body paper discharge opening portion 51, the configuration of such constituent portions disposed above and below the in-body paper discharge opening portion 51 is an example, and is not limited to this arrangement configuration.

In the above configuration, in the present embodiment, a large-format display apparatus (display) 21, arranged so that the lengthwise direction of its screen is oriented vertically, is attached integrally to the rear face case 11a of the image forming apparatus A1 on the back face side (rear face side) of the image forming apparatus A1 as viewed from the operation side (that is, a case on the back face side (rear face side) when viewed from the front of the original capturing portion 53 provided with the operation portion 58), with a first display screen 22 facing toward the outside. That is, in the present embodiment, the image forming apparatus A1 is used as a leg portion of the large-format display 21. Thus, it is possible to fit two large devices, namely the image forming apparatus A1 and the large-format display 21, substantially within the installation space of the image forming apparatus A1. Also, because a connection cord between the image forming apparatus A1 and the large-format display 21 are not exposed to the outside, the appearance is neat, and there is no problem of the connection cord being pulled. However, strictly speaking, a space is necessary for the thickness of the large-format display 21. Thus, even in a small store such as a convenience store or a supermarket, it is possible to install the display-integrated image forming apparatus of the present invention in the same location, almost in the same manner as a conventional image forming apparatus.

Also, the large-format display 21 is configured such that the top of the large-format display 21 protrudes above the case of the image forming apparatus A1. Specifically, the large-format display 21 is disposed such that the top of the large-format display 21 protrudes above the rear face case 11a, and a first display screen 22 is disposed on an opposite face to a second display screen 23 disposed in the protruding portion. Also, it is possible that the second display screen 23 is used as a second operation portion that is different from the operation portion 58, by arranging a touch panel 23a on the second display screen 23. Also, in the above embodiment, the first display screen 22 and the second display screen 23 of the large-format display 21 are provided as a single body, but they may also be separate.

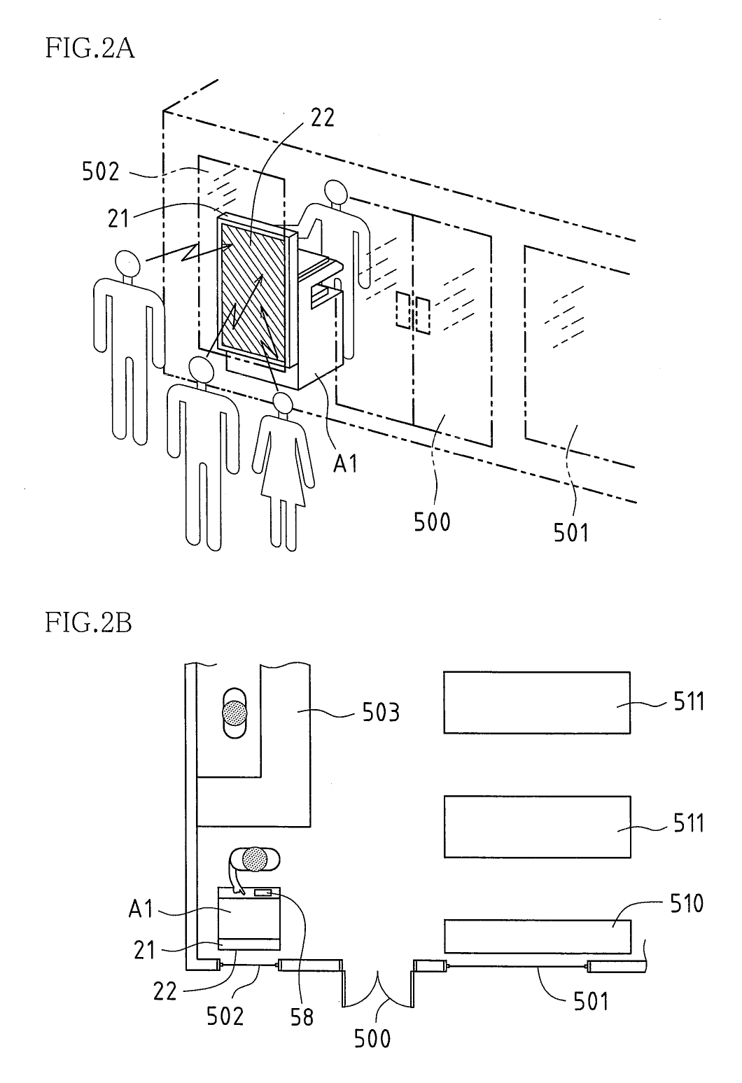

FIG. 2 shows an example in which the display-integrated image forming apparatus configured as described above is installed in a convenience store, with FIG. 2A being a perspective view showing a state in which the image forming apparatus is installed in a convenience store and FIG. 2B being a partial plan view of the convenience store.

That is, in recent convenience stores, the section of the store that faces the street (walkway) is entirely encased in glass by a transparent glass window, and products are displayed such that people walking along the walkway can view and see the state of the inside of the store at a glance. Specifically, in an ordinary arrangement pattern, a wide space-side glass window 501 and a narrow space-side glass window 502 are provided with an entrance 500 between them, a bookshelf 510 is placed along the wide space-side glass window 501, an image forming apparatus A1 is placed along the narrow space-side glass window 502, a register counter 503 is disposed behind the image forming apparatus A1 within the store, and product shelves 511 are disposed behind the bookshelf 510 within the store. In this case, the image forming apparatus A1 is disposed so that the first display screen 22 of the large-format display 21 attached to the rear face faces outside (i.e., the walkway outside the store). Thus, the first display screen 22 of the large-format display 21 faces pedestrians outside the store through the street-side (i.e., the walkway-side) glass window 502. Accordingly, by displaying advertising information on the first display screen 22 of the large-format display 21, it is possible to provide publicity advertisements with impact to pedestrians outside the store. In this case, the second display screen 23 may display the same information as the advertising information displayed on the first display screen 22 installed facing the walkway, or may display information (such as detailed information) related to the advertising information displayed on the first display screen 22. Thus, when a pedestrian interested in the advertised content of the first display screen 22 enters the store and arrives in front of the image forming apparatus A1, detailed information of the advertised content is displayed on the second display screen 23, so by operating a touch panel 23a of the second display screen 23 or the operation portion 58 of the image forming apparatus A1, it is possible to perform printing or the like of desired information. For example, it is possible that when information regarding the issuance of a coupon is displayed on the first display screen 22, if a customer who viewed this information enters the store and operates (touches) a coupon issue button displayed on the detailed information displayed on the second display screen 23, the image forming apparatus A1 prints and outputs a coupon.

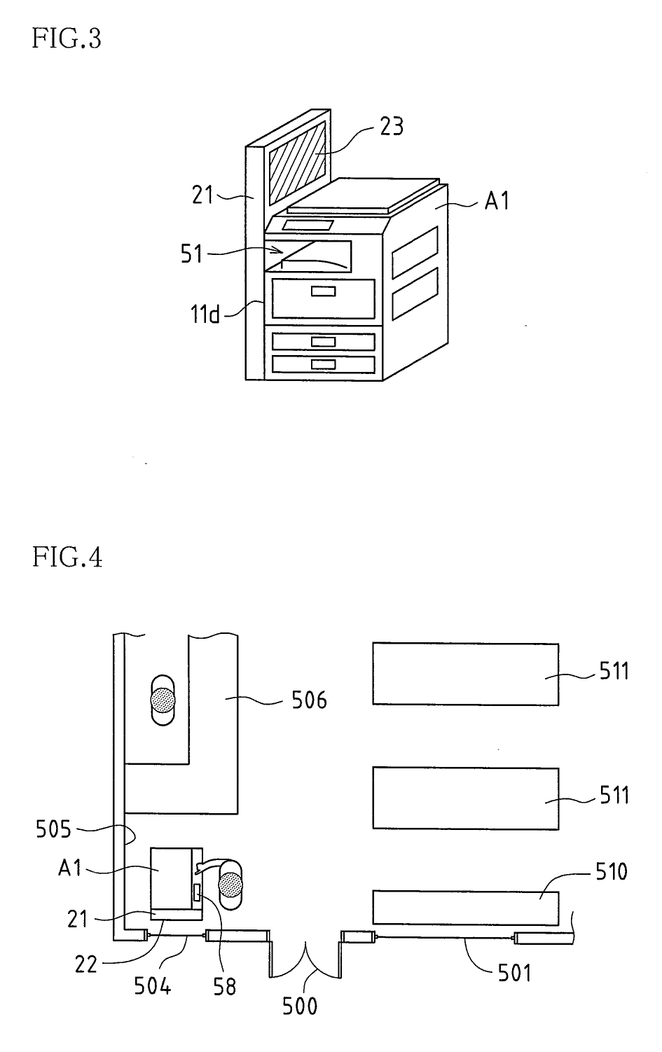

Also, in the above embodiment, an example was described in which the large-format display 21 is attached to the rear face of the image forming apparatus A1, but as long as there is no obstruction to original capturing, taking paper from a discharge tray, replenishing recording paper in a paper cassette, opening/closing doors for maintenance or the like, the large-format display 21 may be attached to, for example, the side face case 11d on one side of the image forming apparatus A1 when viewed from the operation side of the image forming apparatus A1 (that is, when viewed from the front of the original capturing portion 53 provided with the operation portion 58), as shown in FIG. 3.

FIG. 4 shows an example in which the image forming apparatus A1 shown in FIG. 3 is installed in a convenience store. In this example, along a narrow space-side glass window 504, the image forming apparatus A1 is installed in a horizontal orientation relative to the glass window 504 such that the first display screen 22 of the large-format display 21 attached to the side face faces outside (i.e., the walkway outside the store). That is, the image forming apparatus A1 is installed such that the rear face of the image forming apparatus A1 faces a wall 505. Such an installation mode is effective when an adequate space where a user can operate the image forming apparatus A1 cannot be secured between the glass window 504 and a register counter 506, and this installation mode becomes possible by attaching the large-format display 21 to a side face of the image forming apparatus A1.

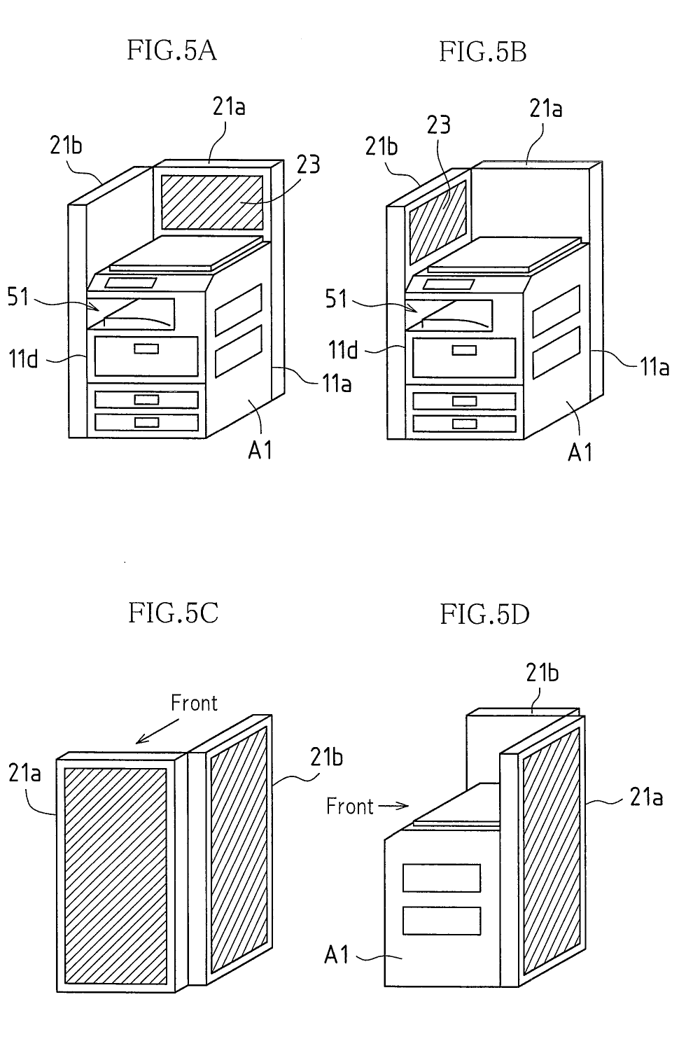

Also, in the above embodiment, an example was described in which the large-format display 21 is attached to the rear face case 11a or the side face case 11d of the image forming apparatus A1, but the large-format display 21 may be attached to, for example, the rear face case 11a and the side face case 11d of the image forming apparatus A1, as shown in FIGS. 5A to 5D. FIG. 5A is a schematic perspective view of a display-integrated image forming apparatus in which there is a second display screen 23 in a large-format display 21a attached to the rear face case 11a, and there is not a second display screen in a large-format display 21b attached to the side face case 11d. FIG. 5B is a schematic perspective view of a display-integrated image forming apparatus in which there is not a second display screen 23 in the large-format display 21a attached to the rear face case 11a, and there is a second display screen in the large-format display 21b attached to the side face case 11d. FIG. 5C is a schematic perspective view of a display-integrated image forming apparatus of FIG. 5A as viewed from the rear. FIG. 5D is a schematic perspective view of a display-integrated image forming apparatus of FIG. 5A as viewed from the other lateral side. Note that in these display-integrated image forming apparatuses shown in FIGS. 5A and 5B, although the second display screen 23 is provided in either the large-format display 21a or the large-format display 21b, the second display screen 23 may be provided in both the large-format display 21a and the large-format display 21b.

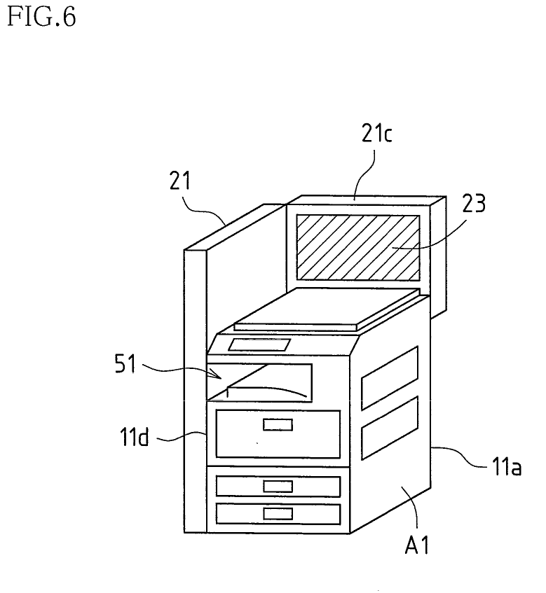

In the above example, the second display screen is disposed on an opposite face to the display screen of the large-format display 21, but it is also possible to, for example, dispose the large-format display 21 on a side face case of the image forming apparatus A1 and dispose a small-format display 21c provided with the second display screen 23 such that it protrudes above the rear face of the image forming apparatus A1 as shown in FIG. 6.

### System Configuration of Display-Integrated Image Forming Apparatus of Present Embodiment

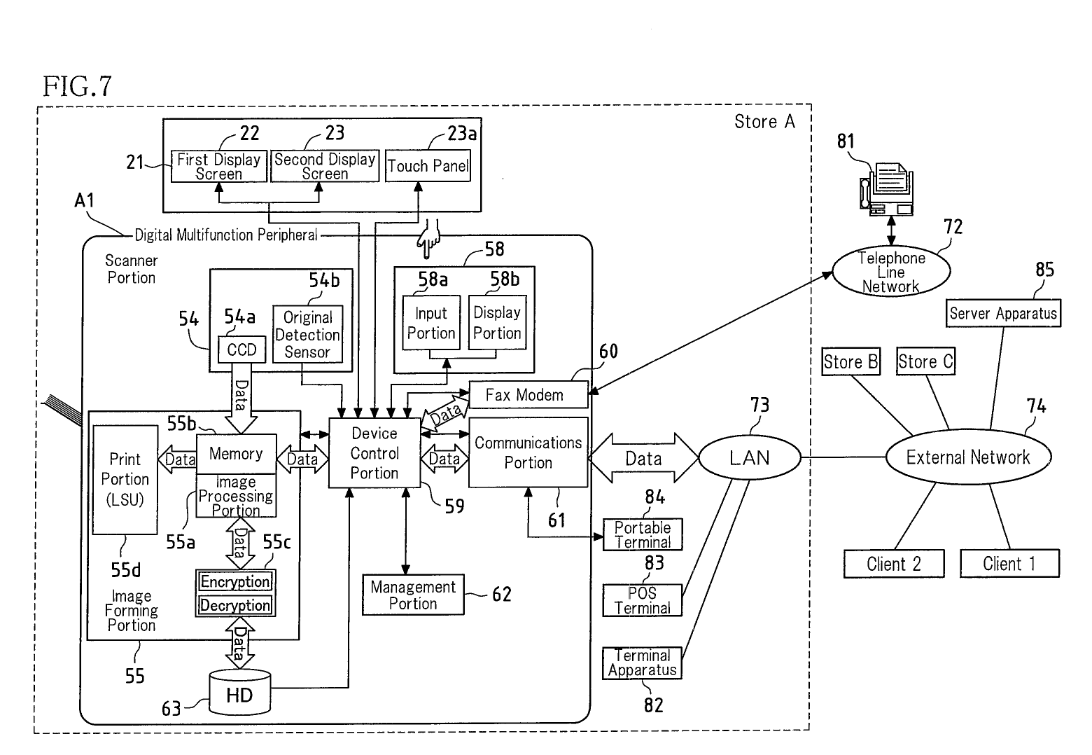

The present embodiment describes an example in which a display-integrated image forming apparatus configured as described above is applied to a digital multifunction peripheral. FIG. 7 shows an overview of the electrical configuration of such a digital multifunction peripheral, and shows a connection relationship between the digital multifunction peripheral and an external server apparatus 85 that manages display information.

First of all, the electrical configuration of the digital multifunction peripheral (image forming apparatus) A1 will be described.

As shown in FIG. 7, the digital multifunction peripheral A1 is provided with a scanner portion 54, an operation portion 58, an image forming portion 55, a device control portion 59, a fax modem 60, a communications portion 61, a management portion 62, and a hard disk (HD) 63. That is, the digital copier of the present embodiment A1 is a multifunction peripheral having a fax machine and a network printer.

The scanner portion 54 is provided with a CCD 54a, an original detection sensor 54b, and so on.

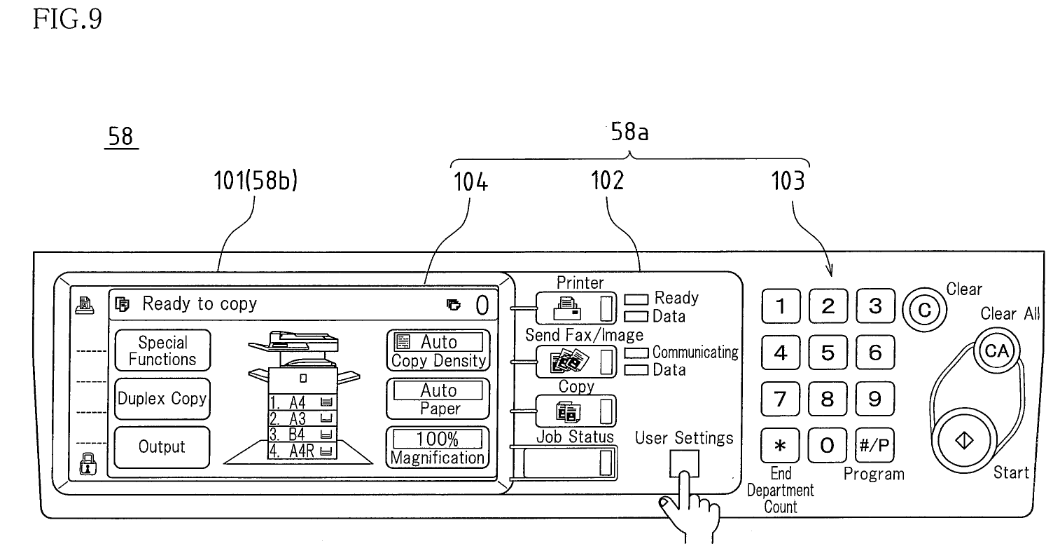

The operation portion 58 is provided with an input portion 58a configured of a touch panel and various function buttons that are mechanical keys, and the like, and a display portion 58b configured of a display panel of liquid crystal or the like. FIG. 9 shows a configuration of the operation portion 58. The display portion 58b has a structure in which a transparent touch panel 104 is disposed on the upper face of a display panel 101, and various function buttons 102 and a numeric keypad 103 are disposed to the side (to the right side in FIG. 9) of the display portion 58b. Furthermore, a start button, a clear all (CA) button, and a clear (C) button are disposed to the right side of the numeric keypad 103.

The image forming portion 55 is provided with an image processing portion 55a that has a work memory 55b where print data is decompressed; an encryption/decryption portion 55c that encrypts data transmitted from outside in order to protect the data in a device, and temporarily saves (stores) the encrypted data to the hard disk 63, and also decrypts the data saved to the hard disk 63 and transfers the decrypted data to the image processing portion 55a; a print portion 55d that has a laser scanning unit (LSU); and the like. Here, the print portion 55d is not limited to an electrophotographic system, and is applicable in various forms, such as an inkjet system or a heat transfer system.

The device control portion 59 manages the operational control of devices, and is configured of a CPU, a ROM, a RAM, and the like. As display control, other than display control of the display portion 58b, the device control portion 59 also controls the display of the first display screen 22 and the second display screen 23 of the large-format display 21.

The management portion 62 manages information necessary for device operation and, for example, with respect to sending and receiving, performs management of mail addresses and fax telephone numbers, and the like. Also, the management portion 62 performs overall management of the information necessary for device operation such as management of location information (address information) of data temporarily saved to the hard disk 63, management of location information of data outputted to the printer when operating in a printer mode, and the like.

The communications portion 61 performs bidirectional communications with an external network 74, and, in the present embodiment, is a printer board provided with a memory for decompressing received data into data that can be handled by a device. Accordingly, with the communications portion 61, received data is, while decompressed in this memory, sequentially transferred to the work memory 55b.

In the digital multifunction peripheral A1 with the above configuration, a facsimile apparatus 81 can be connected to the fax modem 60 via a telephone line network 72. Also, a terminal apparatus (personal computer) 82, a POS terminal 83, and the like can be connected to the communications portion 61 via the LAN 73, and a portable terminal 84 can also be connected to the communications portion 61 via a wireless connection. The communications portion 61 is also capable of being connected to the external server apparatus 85 via the external network 74 and to external branch stores (Store B and Store C) and the like. A client 1 and a client 2 are also connected to the external network 74 to make requests to the server apparatus 85 for the display of advertisements and the like. The digital multifunction peripheral A1 of the present embodiment is disposed in such a network environment.

In the above configuration, for example, data transmitted from the terminal apparatus 82 to the digital multifunction peripheral A1 via the LAN 73 (moving images, still images, text or the like) is stored in the hard disk 63 via the communications portion 61, the device control portion 59, and the image processing portion 55a of the image forming portion 55. Then, the stored data is displayed on the first display screen 22 and the second display screen 23 of the large-format display 21, based on the management information stored in the management portion 62.

The various pieces of information displayed on the first display screen 22 and the second display screen 23 of the large-format display 21, display order, display time and the like are basically managed by the server apparatus 85. It should be noted that the management portion 62 may manage the display order, display time or the like for the display of various pieces of display data stored in the hard disk 63 on the first display screen 22 and the second display screen 23. Accordingly, information unique to the store can be displayed on the first display screen 22 and the second display screen 23 when, for example, the connection with the server apparatus 85 is poor.

In the above embodiment, one large-format display 21 is installed in Store A, but a configuration is also possible in which a plurality of large-format displays 21 are installed, and the external server apparatus 85 performs the display management of these large-format displays 21.

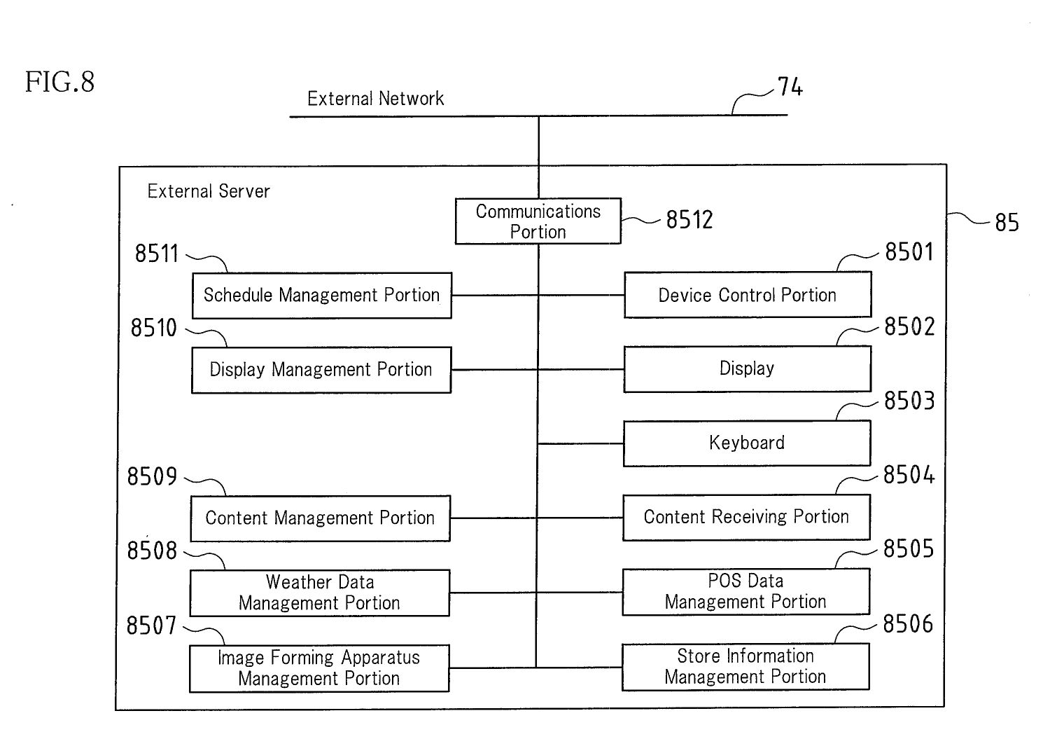

FIG. 8 shows an overview of the electrical configuration of the server apparatus 85.

As shown in FIG. 8, the server apparatus 85 is provided with a device control portion 8501, a display 8502, a keyboard 8503, a content receiving portion 8504, a POS data management portion 8505, a store information management portion 8506, an image forming apparatus management portion 8507, a weather data management portion 8508, a content management portion 8509, a display management portion 8510, a schedule management portion 8511, and a communications portion 8512.

The device control portion 8501 manages the operation control of the whole server, and is configured of a CPU, a ROM, a RAM (not shown) and so on. The display 8502 displays the state and the like of a display apparatus and an image forming apparatus of each store that are managed by the server apparatus 85.

The keyboard 8503 is used to input control instructions and the like to a display apparatus of each store from the server apparatus 85. The content receiving portion 8504 receives display information such as advertisement information, coupon information and the like requested by the client 1, the client 2 and the like via the external network 74, display request information from each store, or information and the like directly inputted into the server apparatus 85.

The POS data management portion 8505 receives and manages information from the POS terminal 83 of each store. The store information management portion 8506 stores and manages regional/local information, such as regional/local events, inputted from the terminal apparatus 82 of each store.

The image forming apparatus management portion 8507 stores and manages the counter information and operation status of the image forming apparatus. The weather data management portion 8508 obtains and manages information sent from an organization that manages weather information (not shown) such as the Meteorological Agency via the external network 74.

The content management portion 8509 stores the information received by the content receiving portion 8504. The display management portion 8510 manages split-screen display, superimposition display and the like of the display screen of the display apparatus of each store.

The schedule management portion 8511 stores and manages the display order, display time and the like of the information stored in the content management portion 8509 for each store in which a large-format display 21 has been installed. The schedule management portion 8511 also manages the change of displayed advertisement content based on the information of each store stored in the POS data management portion 8505 such as product sales status, the information of customers who purchased products, etc., the change of displayed advertisement content according to the time, the change of displayed advertisement content based on the information stored in the weather data management portion 8508 such as regional/local weather, temperature, etc., and the change of displayed advertisement content based on the information stored in the store information management portion 8506 such as regional/local events, etc. The schedule management portion 8511 further manages whether the display data, such as advertisements, to be displayed is a moving image or still image, and in the case of moving image data, the data is transferred to and stored in the HD 63 of a digital multifunction peripheral A1 of each store, and is retrieved from the HD 63 of the digital multifunction peripheral A1 of each store and displayed at a timing according to the display schedule of the schedule management portion 8511. With this configuration, a smooth image display without the influence of data transfer from the server apparatus 85 becomes possible. In the case of still image data, on the other hand, the data is directly transferred to the display apparatus of each store from the content management portion 8509 of the server apparatus 85 and displayed.

The communications portion 8512 performs bidirectional communications with the external network 74, and distributes the information stored in the content management portion 8509 to the large-format display 21 of each store based on the information stored in the schedule management portion 8511. Alternatively, information sent to the server apparatus 85 is temporarily stored in the RAM of the device control portion 8501, and is transferred to the location according to the content of the information sent from the device control portion 8501.

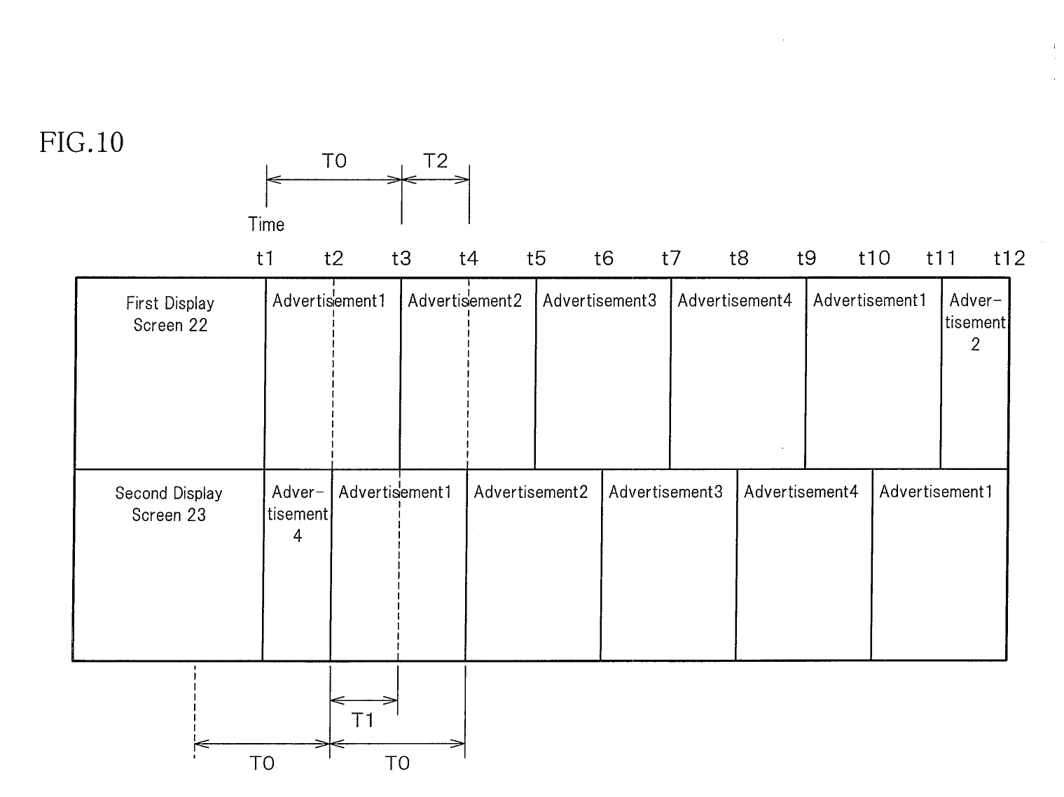

FIG. 10 illustrates an example of the transition of display on the first display screen 22 and the second display screen 23, using the horizontal axis as the time axis.

In the present embodiment, a configuration is adopted in which various pieces of information are displayed on both the first display screen 22 and the second display screen 23, the information that related to the first display screen 22 and the second display screen 23, and the display on the respective display screens is sequentially switched with time. Specifically, the first display screen 22 and the second display screen 23 are configured to perform display by sequentially switching, for example, the display screens of four types of advertisements, namely advertisements 1 to 4, at an interval of a prescribed time T0. The number of advertisements is not limited to four. The image display method of the present embodiment is described below with reference to this example of the transition of display shown in FIG. 10.

In the present embodiment, at time t1, the first display screen 22 displays the advertisement 1, and the second display screen 23 displays the advertisement 4.

From this state, at time t2, while the first display screen 22 continues to display the advertisement 1, display on the second display screen 23 switches from the advertisement 4 to the advertisement 1 due to elapse of the prescribed time T0 since the display of the advertisement 4 has started, although the state prior to time t1 is not shown. Then at time t3 (upon elapse of the prescribed time T0 from time t1), while the display on the first display screen 22 switches from the advertisement 1 to the advertisement 2, the second display screen 23 continues to display the advertisement 1 since the elapsed time T1 from time t2 is not more than the prescribed time T0. At time t4 (upon elapse of the prescribed time T0 from time t2), while the display on the second display screen 23 switches from the advertisement 1 to the advertisement 2, the first display screen 22 continues to display the advertisement 2 since the elapsed time T2 from time t3 is not more than the prescribed time T0.

In this manner, in the present embodiment, a time lag T2 is provided for the timing to switch display between the first display screen 22 and the second display screen 23. It is sufficient that the time lag T2 is arbitrarily set with the use of the operation portion 58 or the touch panel 23a of the second display screen 23. The time required from viewing the first display screen 22 to arriving in front of the second display screen 23 and performing a desired operation differs depending on the installation conditions or the like of the store where the apparatus is installed. Therefore, by enabling the time lag T2 in switching displays to be set arbitrarily, it is possible to set an optimal time lag T2 according to the time required from viewing the first display screen 22 until arriving in front of the second display screen 23 and performing a desired operation.

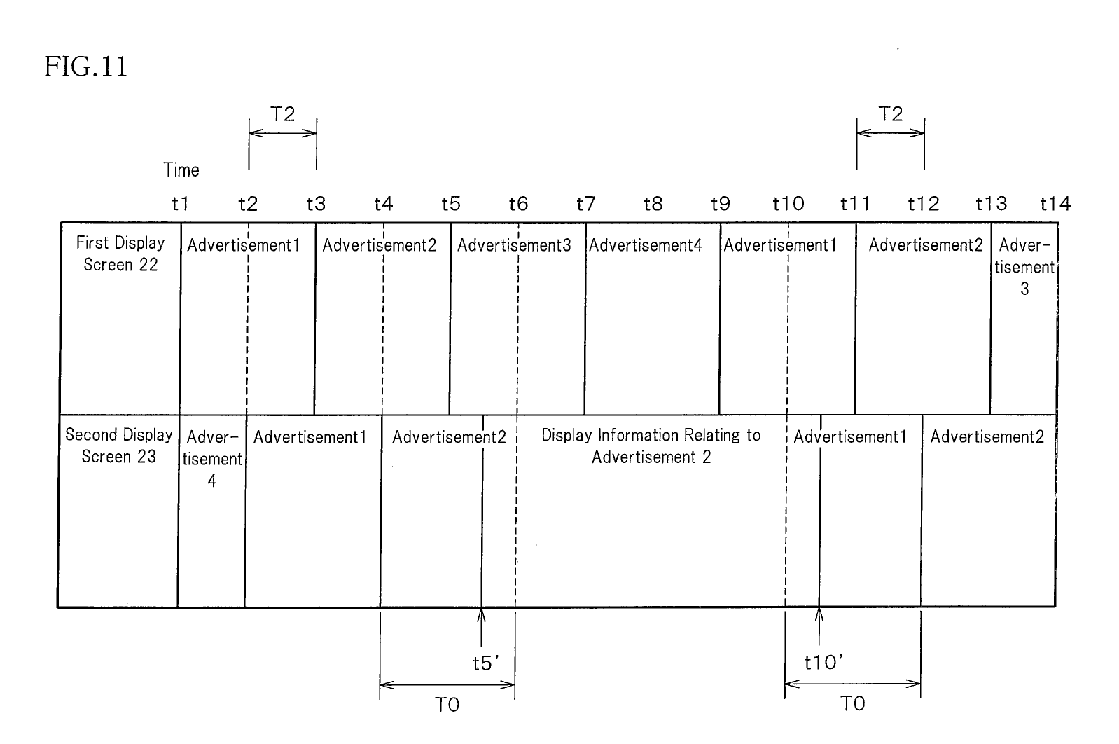

FIG. 11 illustrates an example of the transition of display when an operator has selected desired advertising information during the transition of display in FIG. 10.

Specifically, as shown in FIG. 11, when the operator selects the displayed advertisement 2 at a certain time (time t5,′ for example) between time t4 to time t6, which is the display time for the advertisement 2 on the second display screen 23, through the operation portion 58 or the touch panel 23a of the second display screen 23, while the first display screen 22 continues and repeats display of the advertisements 1, 2, 3, and 4 in transition regardless of such selection by the operator, the second display screen 23, due to the operator having performed the selection operation during display of the advertisement 2, is set to a mode displaying information relating to the advertisemsent 2. Thereafter, the second display screen 23 does not perform the transition of display based on the elapse of the prescribed time T0, and instead continues to display information relating to the advertisement 2.

When the operator prints the selected information with the image forming apparatus A1, transmits the selected information to the portable terminal 84, etc. and thereby completes his/her operation at time t10′, the second display screen 23 returns to the transitional display based on the elapse of the prescribed time T0. In other words, in FIG. 11, since processing such as printing has been completed at time t10′, which is between time t10 and time t11, the second display screen 23 returns to the transitional display based on the elapse of the prescribed time T0 by displaying the advertisement 1, which would have been displayed on the second display screen 23 at that completion time (time t10′) if the transitional display had been continued. In this case, the display time for the advertisement 1 is not the prescribed time T0 starting from time t10′, but the prescribed time T0 from time t10 to t12, during which the advertisement 1 would have been displayed if the transitional display had been continued. Thus, display on the first display screen 22 and the second display screen 23 is switched again with the same time lag, T2.

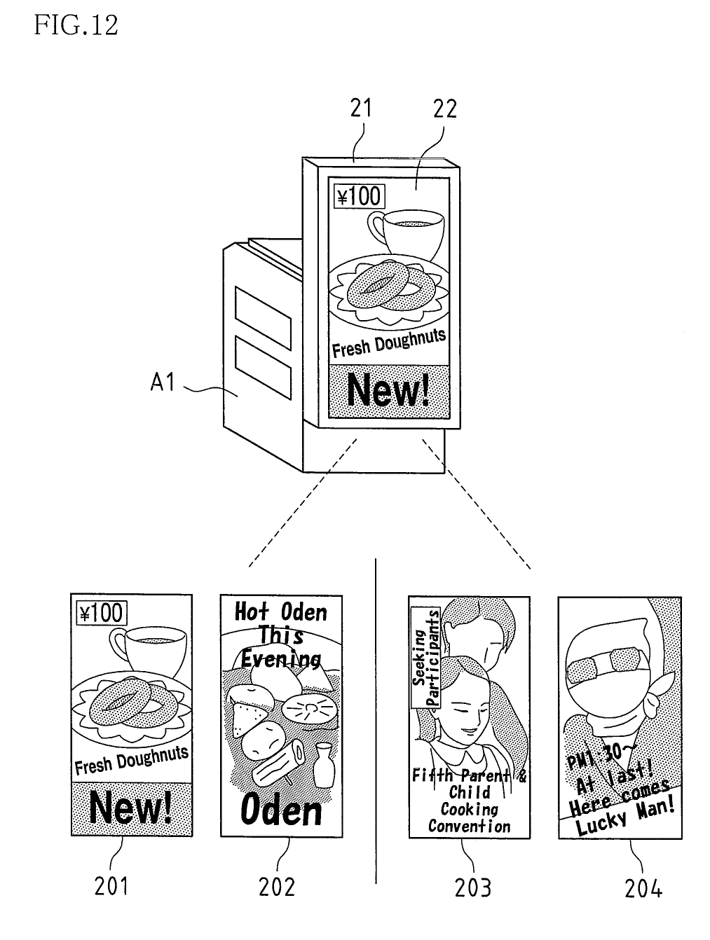

FIG. 12 shows a display example of advertisement data for a convenience store, supermarket or the like displayed on the first display screen 22 of the large-format display 21. In this display example, reference numerals 201 and 202 are display examples of product introduction advertising data focusing on, for example, food, a menu, a new product, or the like, and reference numerals 203 and 204 are display examples of event introduction advertising data that introduces, for example, a function, an event, or the like. By displaying such advertisements on the large-format display 21 disposed near the walkway-side glass window, it is possible to provide publicity advertisements with impact to pedestrians.

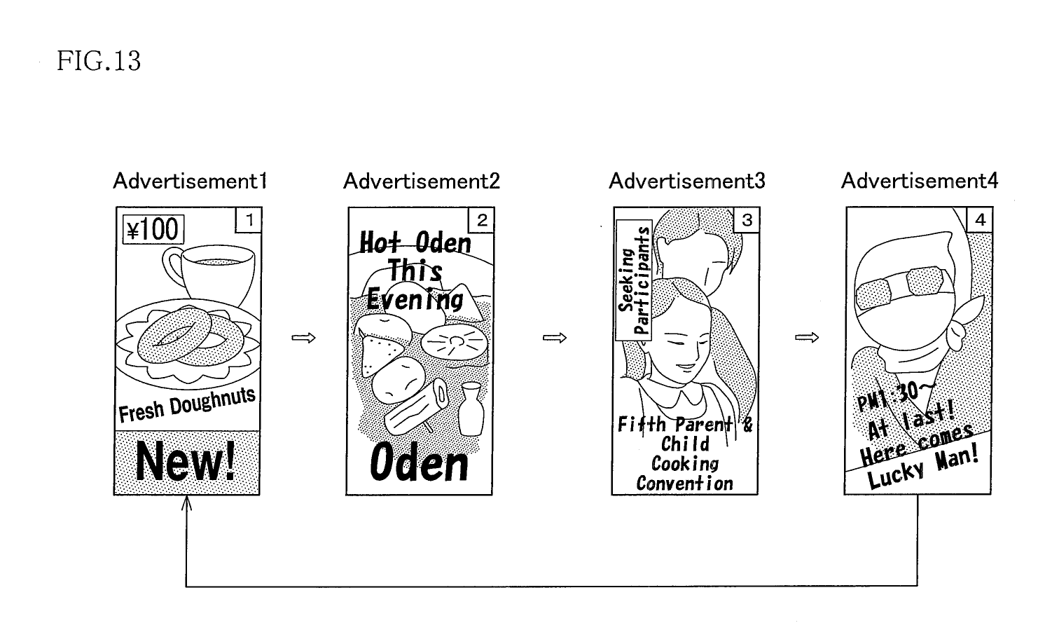

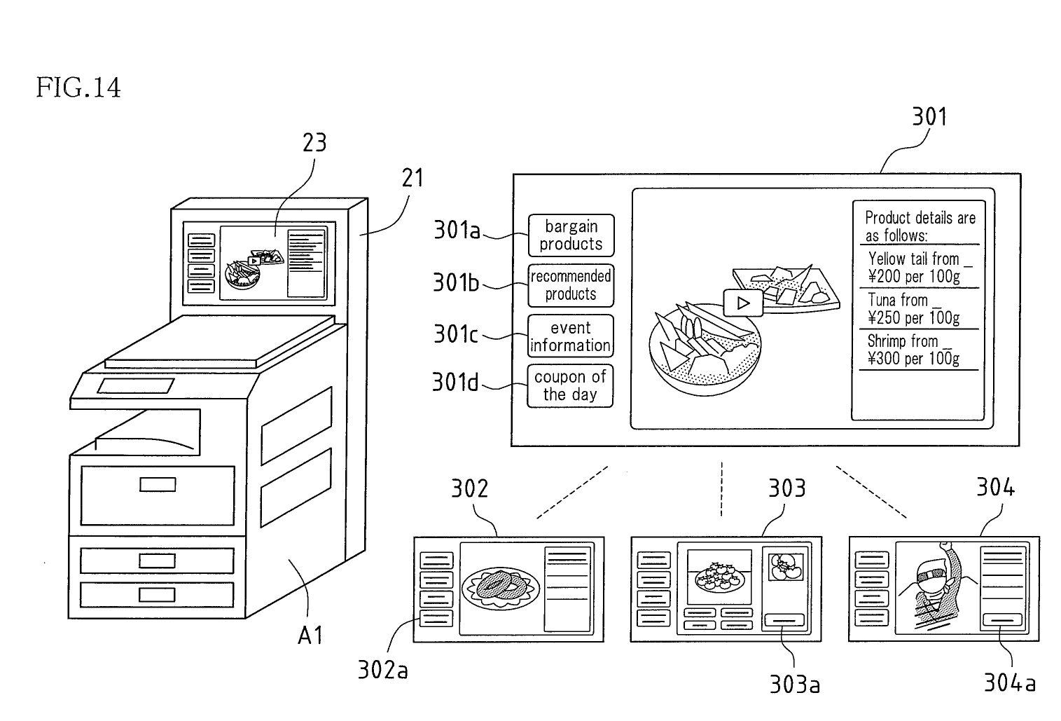

It is assumed here that the advertisement data indicated by reference numerals 201, 202, 203 and 204 of FIG. 12 are sequentially displayed in transition on the first display screen 22 of the large-format display 21 at a prescribed time interval of T0. When a pedestrian who viewed the advertisement data enters the store to obtain data related to the advertisement and arrives in front of the digital multifunction peripheral A1, the images shown in FIG. 13 are sequentially displayed on the second display screen 23 of the large-format display 21 in transition at an interval of prescribed time of T0. In this case, in consideration of the time required for the pedestrian who viewed the first display screen 22 to arrive in front of the second display screen 23, the time lag T2 is provided for switching of the display on the second display screen 23 relative to the switching of the display on the first display screen 22. Accordingly, the pedestrian (customer) who arrived in front of the second display screen 23, since the same image that the customer viewed on the first display screen 22 is still displayed on the second display screen 23, touches the second display screen 23 or inputs a desired number using the input portion 58a of the operation portion 58 (it is assumed here that “2” has been selected) and, thereby, a food information top page indicated by reference numeral 301 of FIG. 14 is displayed as information related to the selected information. At this time, the display on the first display screen 22 continues to be switched at an interval of the prescribed time T0 and, therefore, the advertisements 1 to 4 are repeatedly displayed to the pedestrians outside the store, thereby maintaining the advertising publicity functionality.

Meanwhile, the second display screen 23 displaying the food information top page is provided with a touch panel 23a for inputting operations, so if the customer (operator) who views this screen touches, for example, “Bargain Products” 301a, bargain information indicated by reference numeral 302 is displayed on the second display screen 23. Then, if the operator touches, for example, “Coupon of the Day” 302a of the bargain information screen, although not shown, a screen for confirming whether or not to print a coupon is displayed, and when the operator then touches “Print” in that screen, the device control portion 59 receives this instruction, reads the data for the bargain product of the day and coupon data that are saved in the hard disk 63 or the content management portion 8509 of the server apparatus 85, and prints/outputs those pieces of data via the image processing portion 55a and the print portion 55d. That is, a coupon is issued. In order to prevent the issuance of an excessive amount of coupons unnecessarily, a method can be adopted in which the data is transmitted to a portable terminal 84, such as a cell phone.

If the operator who viewed the food information top page screen 301 shown in FIG. 14 touches, for example, “Recommended Products” 301b, recommended product information indicated by reference numeral 303 is displayed on the second display screen 23. Then, if the operator touches, for example, “Print” 303a of the recommended product information screen 303, the device control portion 59 receives this instruction, reads the description data of a recommended product and recipe data that uses the recommended product that are saved in the hard disk 63 or the content management portion 8509 of the server apparatus 85, and prints/outputs those pieces of data via the image processing portion 55a and the print portion 55d.

If the operator who viewed the food information top page screen 301 shown in FIG. 14 touches, for example, “Event Information” 301c, event information indicated by reference numeral 304 is displayed on the second display screen 23. Then, if the operator touches “Print” 304a of the event information screen 304, the device control portion 59 receives this instruction, reads the description data for a time-limited sale or the present month's event information and ticket data for participating in those events that are saved in the hard disk 63 or the content management portion 8509 of the server apparatus 85, and prints/outputs those pieces of data via the image processing portion 55a and the print portion 55d. That is, a ticket is issued.

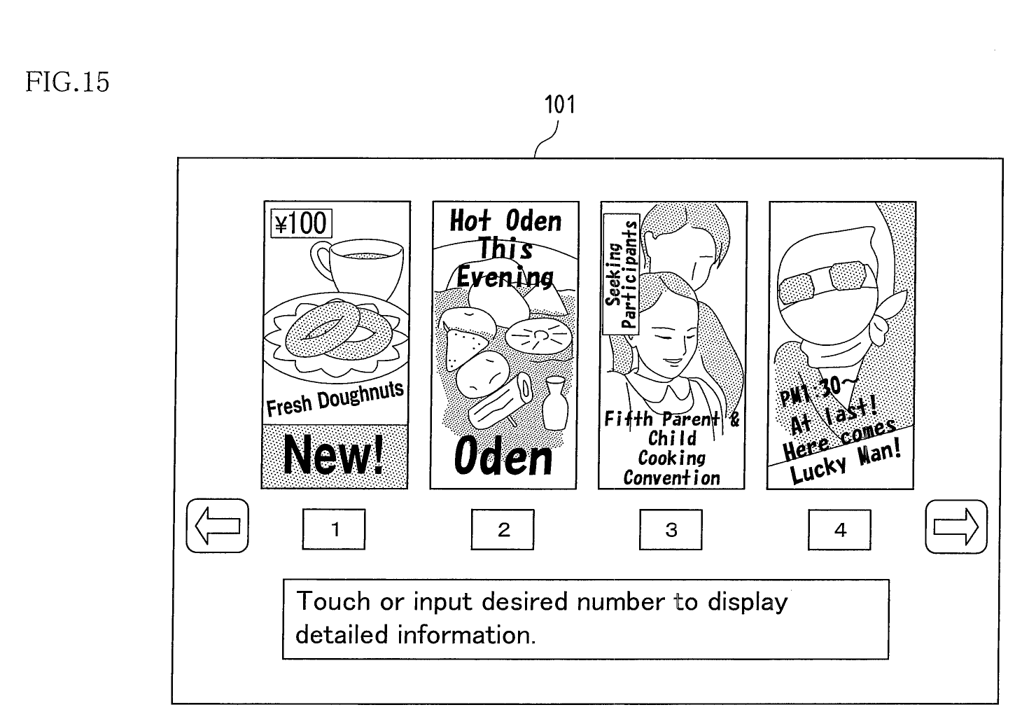

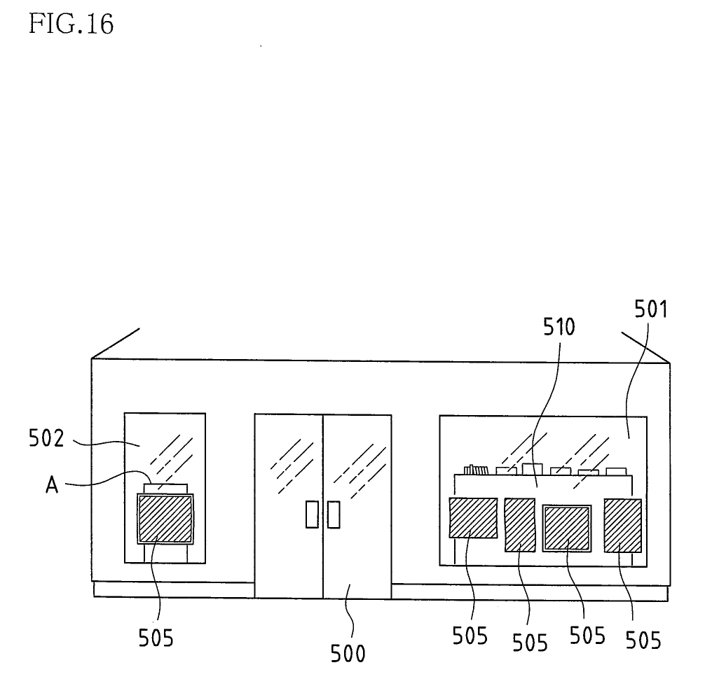

If the operator who viewed the food information top page screen 301 shown in FIG. 14 touches, for example, “Coupon of The Day” 301d, although not shown, a list of issuable coupons is displayed, and when the operator touches a desired coupon from that list and then touches “Print” (not shown), the device control portion 59 receives this instruction, reads the data for that coupon saved in the hard disk 63 or the content management portion 8509 of the server apparatus 85, and prints/outputs that data via the image processing portion 55a and the print portion 55d. That is, a coupon is issued. Although not described in the above example, it is also possible to display thumbnail images as shown in FIG. 15 on the display panel 101 of the operation portion 58 of the digital multifunction peripheral A1.

As the recording paper used when various pieces of data displayed on the large-format display 21 is printed/outputted with the digital multifunction peripheral A1, recording paper different from that used when providing a copy service for a fee can be used. That is, the print/output of data displayed on the large-format display 21 is provided as a service for the purpose of securing store customers, so it is necessary to allow consumers to use this service as a free service without concern. In other words, it is assumed that this service is provided free of charge. Accordingly, when printing/outputting data displayed on the large-format display 21, by using recording paper with advertising printed on the back, it is possible to have the advertiser bear the burden of the cost of printing, and thus allow consumers to print data as a free service without concern.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A display-integrated image forming apparatus comprising:
an image forming apparatus that performs a print operation with a print portion in response to an operation through an operation portion;
a first display apparatus arranged at least on one side of a case of the image forming apparatus, the first display apparatus including a first display screen viewable from a rear face or a side face when viewed from an operation side of the image forming apparatus;
a second display apparatus arranged so as to protrude above the case of the image forming apparatus, the second display apparatus including a second display screen viewable by an operator of the image forming apparatus; and
a display control portion that displays various pieces of information that related to the first display screen and the second display screen, and sequentially switches the display on the first display screen and the second display screen with time,
wherein the display control portion switches the display on the first display screen and the display on the second display screen with a time lag.

2. The display-integrated image forming apparatus according to claim 1,
wherein, aside from the operation portion, the second display screen serves as a second operation portion, and operation is possible from either or both of the operation portion and the second operation portion.

3. The display-integrated image forming apparatus according to claim 1,
wherein the time lag can be set arbitrarily.

4. The display-integrated image forming apparatus according to claim 1,
wherein, when a desired piece of information is selected from the information displayed on at least one of the first display apparatus and the second display apparatus, the display control portion displays the selected piece of information on the second display screen, and a transitional display in which display on a screen is sequentially switched with time is suspended for the second display screen.

5. The display-integrated image forming apparatus according to claim 4,
wherein the transitional display in which display on a screen is sequentially switched with time is continued for the display of the first display screen.

6. The display-integrated image forming apparatus according to claim 4,
wherein when processing based on the selected piece of information displayed on the second display screen is completed, the display on the second display screen returns to the transitional display in which display on a screen is sequentially switched with time.

7. The display-integrated image forming apparatus according to claim 1,
wherein information displayed on at least one of the first display screen and the second display screen is managed by a management portion of the image forming apparatus.

8. An image display system,
wherein the display-integrated image forming apparatus according to claim 1 and a server apparatus are connected to each other via a network, and
information displayed on at least one of the first display screen and the second display screen is managed by the server apparatus.

9. An image display method, the method being employed in the display-integrated image forming apparatus according to claim 1, and comprising the steps of:
displaying various pieces of information that related to the first display screen and the second display screen, and sequentially switching display on the first display screen and the second display screen with time; and
switching the display on the first display screen and the display on the second display screen with a time lag.

10. The image display method according to claim 9, further comprising the steps of:
when a desired piece of information is selected through the operation portion from the information displayed on at least one of the first display screen and the second display screen, displaying the selected piece of information on the second display screen, and suspending transitional display in which display on the second screen is sequentially switched with time for the second display screen, and
when processing based on the selected piece of information displayed on the second display screen is completed, returning the display of the second display screen to the transitional display in which display on the second screen is sequentially switched with time.
